(19) United States
(12) Patent Application Publication
(10) Pub. No.: US 2016/0188060 A1
(43) Pub. Date: Jun. 30, 2016

(54) TOUCH DISPLAY DEVICE AND DRIVING METHOD THEREOF

(71) Applicant: HON HAI PRECISION INDUSTRY CO., LTD., New Taipei (TW)

(72) Inventors: FENG-HSIANG LIU, Tu-Cheng (TW); WEI-CHENG CHEN, Tu-Cheng (TW)

(21) Appl. No.: 14/832,817

(22) Filed: Aug. 21, 2015

(30) Foreign Application Priority Data
Dec. 24, 2014 (CN) 201410812945.3

(51) Int. Cl. G06F 3/041; G06F 3/044

(52) U.S. Cl. CPC G06F 3/0412; G06F 3/044; G06F 3/0416

(57) ABSTRACT

A touch display device is provided. The touch display device includes: a plurality of pixel electrodes configured to receive image data to be displayed; a plurality of common electrodes; a plurality of touch sensitive electrodes; common voltage generator configured to generate a first common voltage and a second common voltage, and a selection circuit, coupled between the common voltage generator and the plurality of common electrodes. The first common voltage is a first direct voltage, and the second common voltage is an alternating voltage switched between a second direct voltage and a third direct voltage. The selection circuit is configured to selectively output the first common voltage to the common electrodes during a first time period and selectively output the second common voltage to the common electrodes during a second time period.

### FIELD

The subject matter herein generally relates to a touch display device and a driving method for a touch display device.

### BACKGROUND

Generally, an in-cell touch display device can include common electrodes, touch sensitive electrodes, and pixel electrodes. The common electrodes can operate as touch driving electrodes and cooperate with the touch sensitive electrodes to identify touch operations applied on the touch display device during a touch scanning period. The common electrodes can operate with pixel electrodes to display images on the touch display device during display scanning period. Each touch scanning period alternate with each display scanning period. Voltages of the common electrodes during a touch scanning period may be unstable due to voltage fluctuation of the common electrodes during a display scanning period prior to the touch scanning period, thus reducing accuracy of touch sensing.

### BRIEF DESCRIPTION OF THE DRAWINGS

Implementations of the present technology will now be described, by way of example only, with reference to the attached figures.

FIG. 1 is an isometric view of an exemplary embodiment of a touch display panel, the touch display panel including a first substrate.

FIG. 2 is a cross sectional view taking along line II-II of the touch display panel in FIG. 1.

FIG. 3 is a diagrammatic view of an exemplary embodiment of a driving layer of the first substrate in FIG. 1.

FIG. 4 is a diagrammatic view of an exemplary embodiment of a relationship between the driving layer and common electrodes.

FIG. 5 is a diagrammatic view of an exemplary embodiment of a relationship between common electrodes and touch sensitive electrodes.

FIG. 6 is a block diagram of an exemplary embodiment of an in-cell touch display device including a touch display panel.

FIG. 7 is a diagrammatic view of an exemplary embodiment of a configuration of blocks of a touch display panel.

FIG. 8 is a diagrammatic view of an exemplary embodiment of sequential waveforms of an in-cell touch display device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

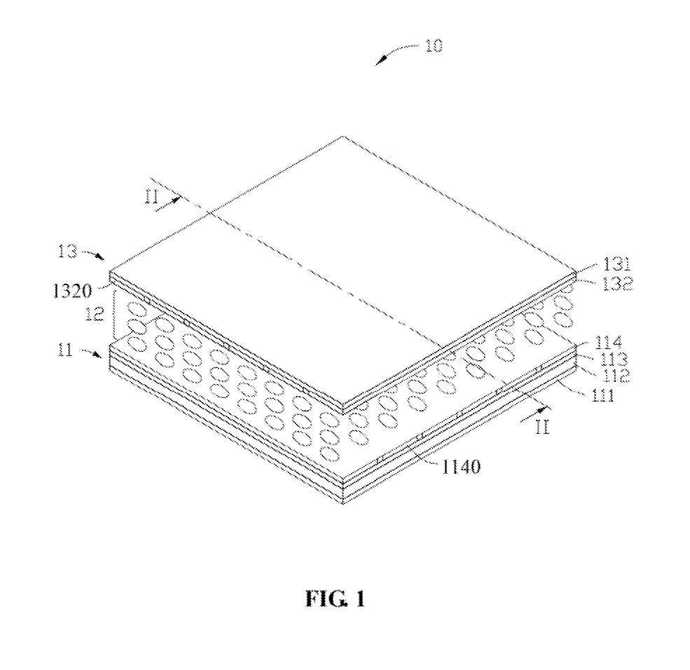

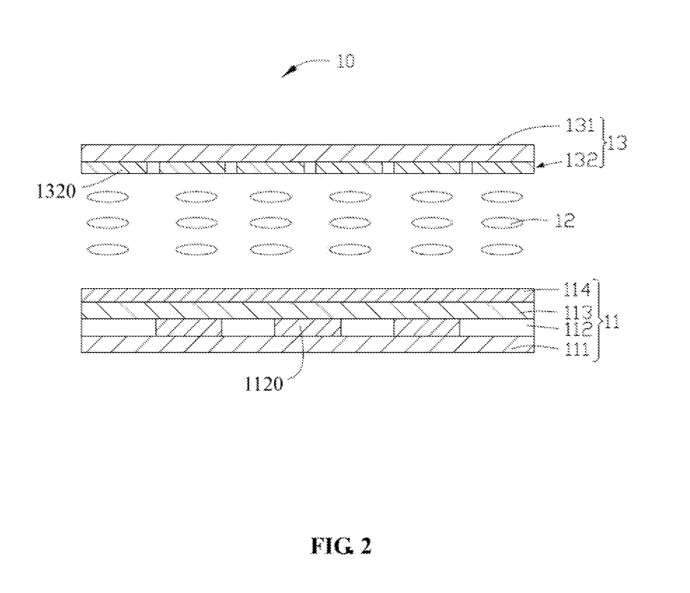

FIGS. 1 and 2 illustrate an exemplary embodiment of a touch display panel 10. In the exemplary embodiment, the touch display panel 10 can be configured to display images instantaneously in time sequence and sensing touch operations on the touch display panel 10. In the exemplary embodiment, the touch display panel 10 can be an in-cell touch display panel. In at least one exemplary embodiment, the touch display panel 10 can be any currently available touch display panel.

The touch display panel 10 can include a first substrate 11, a second substrate opposite to the first substrate 11, and a liquid crystal layer 12 arranged between the first substrate 11 and the second substrate 13. The first substrate 11 can be an array substrate and can be named as to a lower substrate. The first substrate 11 can include a first substrate base 111, a driving layer 112, an insulating layer 113, and a common electrode layer 114. The driving layer 112 can be arranged on the first substrate base 111 and covered by the insulating layer 113. The driving layer 112 can include a plurality of pixel electrodes 1120 arranged in a substantially rectangle configuration. The common electrode layer 114 is arranged on the insulating layer 113 and can include a plurality of common electrodes 1140. A horizontal electric field can be generated between the plurality of pixel electrodes 1120 and the plurality of common electrodes 1140, which can drive liquid crystal molecules of the liquid crystal layer 12 to deflect so as to cause the touch display device to display images.

The second substrate 13 can be named as an upper substrate or a color film substrate. The second substrate 13 can include a second substrate base 131 and a touch sensitive electrode layer 132. The touch sensitive electrode layer 132 can include a plurality of touch sensitive electrodes 1320 arranged at regular interval along a first direction. The touch sensitive electrodes 1320 can be configured to detect touch operations on the touch display panel 10. The touch sensitive electrodes 1320 can be configured to operate with the common electrodes 1140 to identify positions where the touch operations are applied.

In the exemplary embodiment, the first substrate base 111 and the second substrate base 131 can be made of transparent glass or plastic. The pixel electrodes 1120, the common electrodes 1140, and the touch sensitive electrodes 1320 can be made of Indium Tin Oxide (ITO) or Indium Zinc Oxide (IZO). In at least one exemplary embodiment, the first substrate base 111 and the second substrate base 131 can be made of any suitable material. The pixel electrodes 1120, the common electrodes 1140, and the touch sensitive electrodes 1320 can be made of any suitable materials.

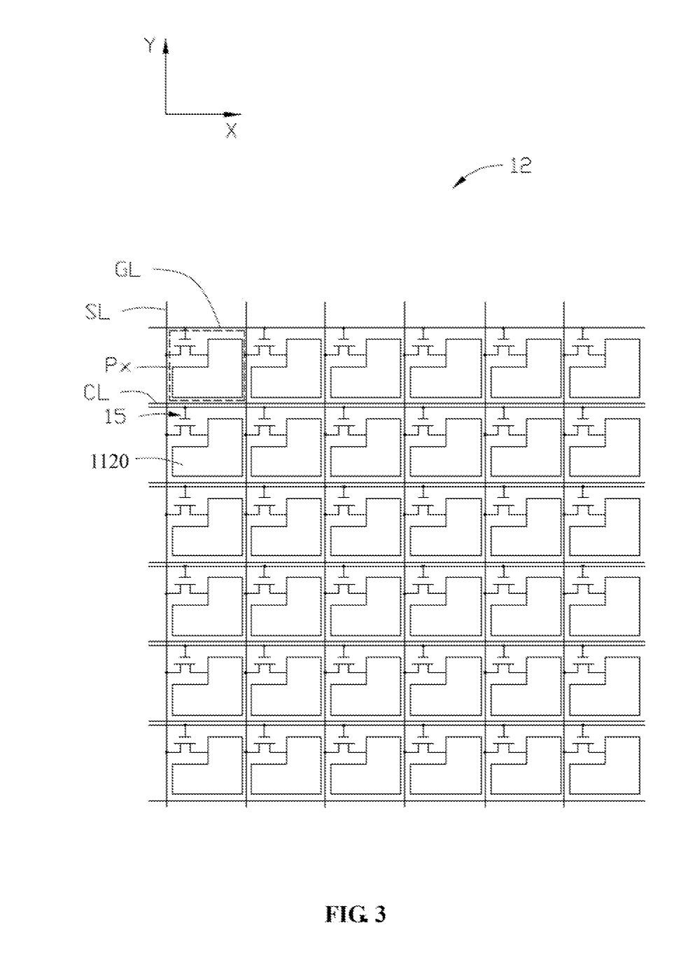

FIG. 3 illustrates a diagrammatic view of an exemplary embodiment of the driving layer 112. The driving layer 112 can include a plurality of gate lines (GLs) parallel to each other, a plurality of source lines (SLs) which are perpendicularly and insulatively intersect the GLs, and a plurality of common electrode lines (CLs) which are insulated from the GLs and CLs and are parallel to the GLs. The GLs can be referred to as scanning lines and the SLs can be referred to as data lines. The GLs, CLs and the SLs intersect with each other to define a plurality of pixel units Pxs which are arranged in a rectangle configuration. Each pixel unit Px can include a Thin Film Transistor (TFT) 15 and a pixel electrode 1120 coupled with the TFT 15. The GLs and the CLs extend along a first direction (For example, along X axis), while the SLs extends along the second direction (for example, along Y axis) different from the first direction.

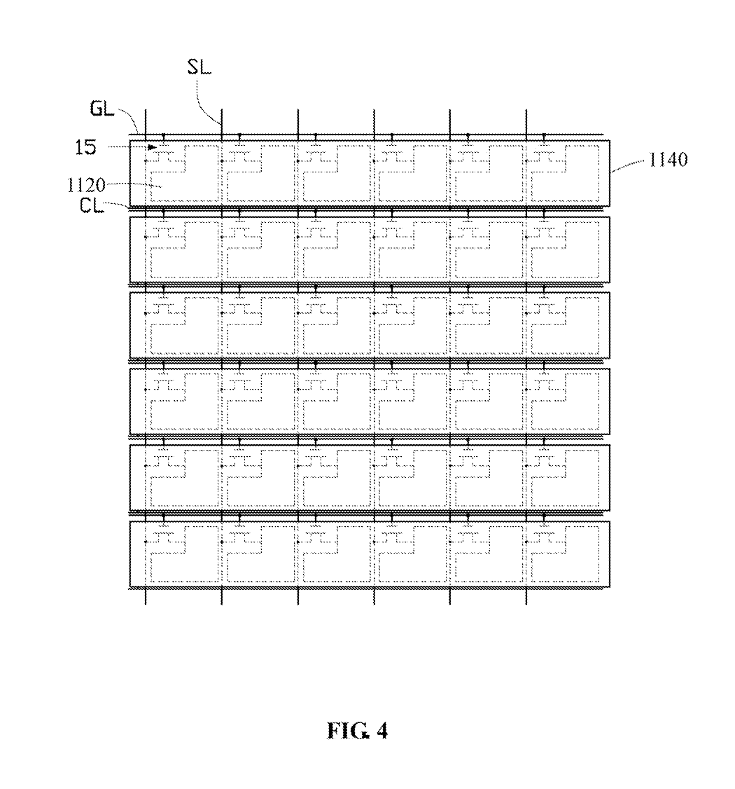

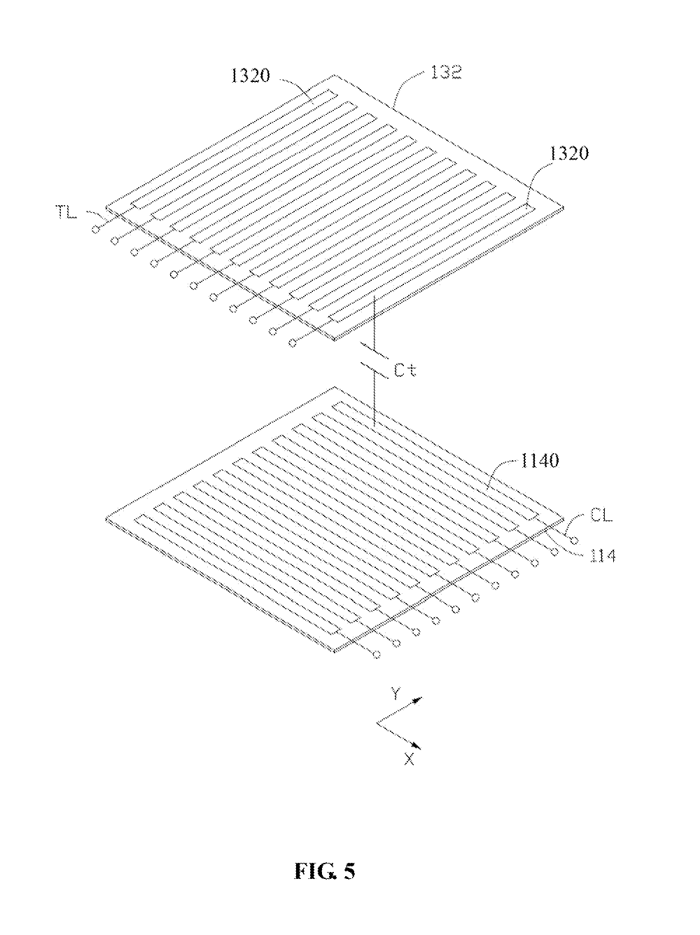

FIGS. 3, 4 and 5 illustrate that the plurality of common electrodes 1140 can be spaced arranged along the second direction and can be insulated from each other. Each common electrode 1140 can be coupled with one of the common electrode lines CLs and can be in a substantially rectangle shape. Each common electrode 1140 can be corresponding to a row of pixel units Pxs. That is, the number of the common electrodes 1140 can equal to the number of rows of the pixel units Pxs. Orthographic projection of each common electrode at a plane where the plurality of pixel units Pxs is located can overlap a corresponding row of pixel units Pxs. In at least one exemplary embodiment, the common electrode 1140 can be in any other suitable shape, for example, parallelogram, ellipse.

The plurality of touch sensitive electrodes 1320 can be spaced arranged along the first direction and can be insulated from each other. The plurality of touch sensitive electrodes 1320 can be intersected insulatively with the plurality of common electrodes 1140. In the exemplary embodiment, the touch sensitive electrodes 1320 can be in a substantially rectangle shape. When the touch sensitive electrodes 1320 and the common electrodes 1140 are powered, sensing capacitance Ct is generated between the touch sensitive electrodes 1320 and the common electrodes 1140 to detect touch operations on the touch display panel 10. Alternatively, the touch sensitive electrodes 1320 can be substituted for some signal lines arranged at the first substrate 11, for example, extra sensing electrodes arranged on the first substrate 11.

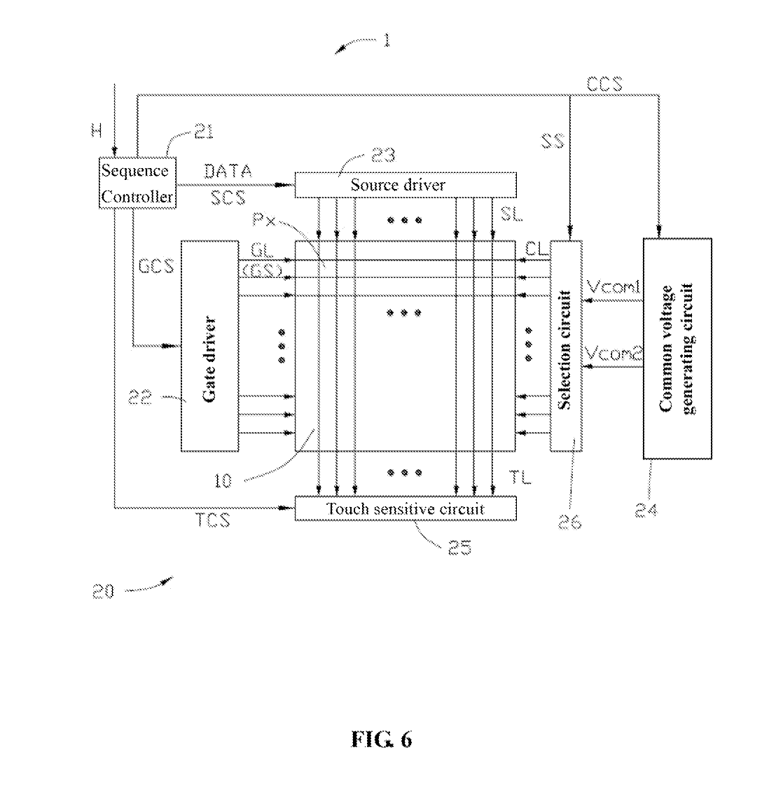

FIG. 6 illustrates a block diagram of an exemplary embodiment of an in-cell touch display device 1. The in-cell touch display device 1 can include the touch display panel 10 and a driving circuit system 20. In detail, the driving circuit system 20 can be configured to drive the touch display panel 10 to display images and to detect touch operations on the touch display panel 10. In the exemplary embodiment, the driving circuit system 20 can include a sequence controller 21, a gate driver 22, a source driver 23, a common voltage generating circuit 24, a touch sensitive circuit 25, and a selection circuit 26. It should be noted that the name of all the elements shown and described above are used for illustrative purpose only and cannot be limitations to the embodiments. In at least one embodiment, the gate driver 22 and the source driver 23 can be substituted for a display driver (or a display driving chip or a display driving circuit).

The sequence controller 21 can be configured to receive horizontal synchronizing signals H from an outside system, output gate control signals GCS to the gate driver 22, output source control signals SCS and image data DATA to the source driver 23, output common voltage control signals CCS to the common voltage generating circuit 24, and output selection signals SS to the selection circuit 26. The sequence controller 21 further can be configured to output touch control signals TCS to the touch sensitive circuit 25.

The gate driver 22 can be coupled to the pixel unit Px through the GLs, and can transmit gate signals GS (also referred to as scanning signals) to the pixel unit Px through the GLs in response to the gate control signals GCS so as to selectively enable corresponding pixel units PXs. The source driver 23 can be coupled to the pixel unit Px through the SLs, and can transmit the image data DATA to the pixel unit Px through the SLs so as to cause the pixel unit Pxs to display images.

The common voltage generating circuit 24 can be configured to generate common voltages Vcom with at least two different waveforms. In the exemplary embodiment, the common voltages Vcom with at least two different waveforms can include a first common voltage Vcom1 and a second common voltage Vcom2. The first common voltage Vcom1 can be a direct voltage (DC) with a first constant voltage and can be applied on the common electrodes during a display scanning period. In the exemplary embodiment, the first constant voltage can be 0V. The second common voltage Vcom2 can be an alternating voltage (AC) with a voltage varying between a second constant voltage and a third constant voltage and can be applied on the common electrodes during a touch scanning period. The second common voltage Vcom2 can be served as touch control signals applied to the common electrodes 1140. In the exemplary embodiment, the second constant voltage can be 0V, while the third constant voltage can be 3.5V.

In at least one embodiment, the first constant voltage, the second constant voltage and the third constant voltage can be any other suitable values, for example, the first constant voltage can be −3V, the second constant voltage can be 0V, and the third constant voltage can be 3.5V.

The selection circuit 26 can be coupled to the common voltage generating circuit 24 and be coupled to the common electrodes 1140 through the CLs. The selection circuit 26 can be configured to receive the first common voltage Vcom1 and the second common voltage Vcom2 and to transmit the first common voltage Vcom1 and the second common voltage Vcom2 to corresponding common electrodes 1140 in response to the selection signals SS.

The touch sensitive circuit 25 can be coupled to the touch sensitive electrodes 1320 through touch sensitive lines TLs and to receive touch signals TS in response to the touch control signals TCS. The touch sensitive circuit 25 can be configured to process and analyze the touch signals TS so as to identify a position where a touch operation applied on the touch display panel 10.

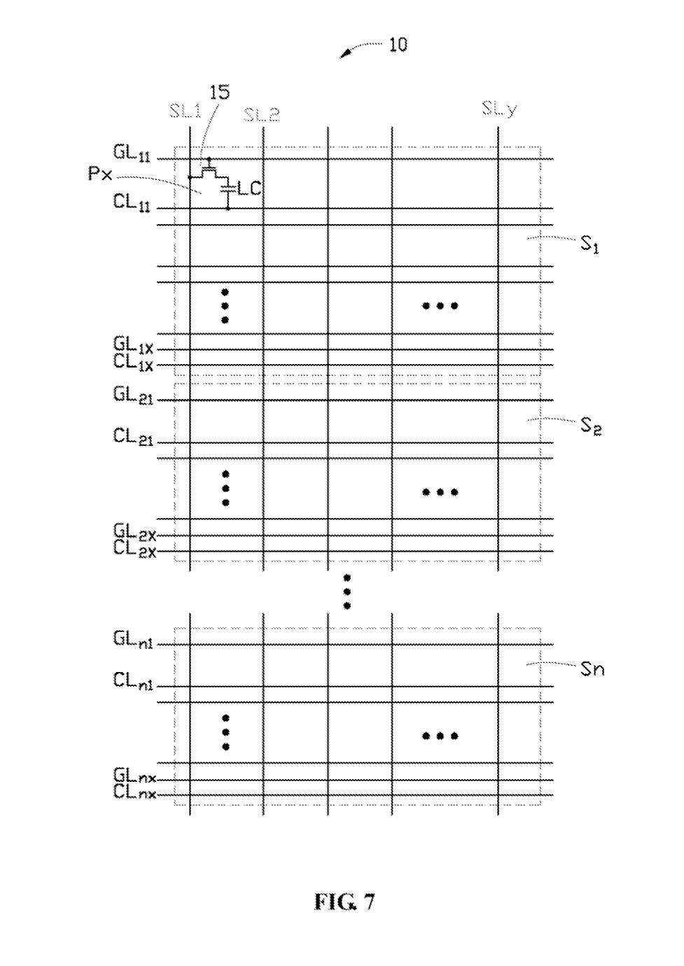

FIG. 7 illustrates a diagrammatic view of an exemplary embodiment of a configuration of blocks of a touch display panel. The gate lines GLs intersect the source lines

SLs to define a plurality of pixel units Pxs. The pixel units Pxs are arranged in a matrix configuration. Each pixel unit Px can include a Thin Film Transistor (TFT) 15 and a liquid crystal capacitor LC. The liquid crystal capacitor LC can include a pixel electrode 1120, a liquid crystal layer 12 and a common electrode 1140 as illustrated in FIGS. 1, 2, 3 and 4. The TFT 15 can be coupled to a gate line GL, a source line SL, and the pixel electrode 1120. In detail, a gate of the TFT 15 can be coupled to the gate line GL to receive the gate signals GSs. A source of the TFT 15 can be coupled to the source line SL to receive the image data DATA. A drain of the TFT 15 can be coupled to the pixel electrode 1120. The TFT 15 can be enabled by the gate signal GS to receive the image data DATA at the source of the TFT 15. The image data DATA is then transmitted to the drain of the TFT 15 and the pixel electrode 1120. When the common electrode 1140 is applied a voltage, an electric field can be generated in the liquid crystal capacitor LC to drive liquid crystal molecules of the liquid crystal layer 12 to deflect, thus displaying the image on the touch display device 1.

The touch display panel 10 defines a plurality of touch sensing area S arranged along a direction of the gate lines arranged, for example, the second direction Y). In the exemplary embodiment, the touch sensing area S can include S1, S2 . . . Sn, n being a positive integer. Each one of the touch sensing area can include x gate lines such as GLm1, GLm2, . . . GLmx, Y source lines such as SL1, SL2, . . . Sly, and x common electrode lines such as CLm1, CLm2, . . . CLmx, x, y being a positive integer, m=1, 2, . . . n.

For example, the first touch sensing area 51 can include gate lines GL11, GL12, . . . GL1x, source lines SL1, SL2, . . . Sly, and common electrode lines CL11, CL12, . . . CL1x. The second touch sensing area S2 can include gate lines GL21, GL22, . . . GL2x, source lines SL1, SL2, . . . Sly, and common electrode lines CL21, CL22, . . . CL2y. The n^{th} touch sensing area Sn can include gate lines GLn1, GLn2, . . . GLnx, source lines SL1, SL2, . . . Sly, and common electrode lines CLn1, CLn2, . . . CLnx.

During a display scanning period, the pixel electrode 1120 receives the image data DATA and the common electrode 1140 is applied the first common voltage Vcom1, so that an electric field is generated in the liquid crystal capacitor LC to drive the liquid crystal molecules to deflect.

During a touch scanning period, the common electrode 1140 is applied the second common voltage Vcom2, so that an electric field is generated in a sensing capacitor Ct formed between the common electrode 1140 and the pixel electrode 1120. The electric field in the sensing capacitor Ct can be changed by a touch operation applied on the touch display panel 10 so as to generate a touch signal TS. The touch signal TS is then transmitted to the touch sensitive circuit 25. The touch sensitive circuit 25 can process and analyze the touch signal TS to identify a position where the touch operation is applied.

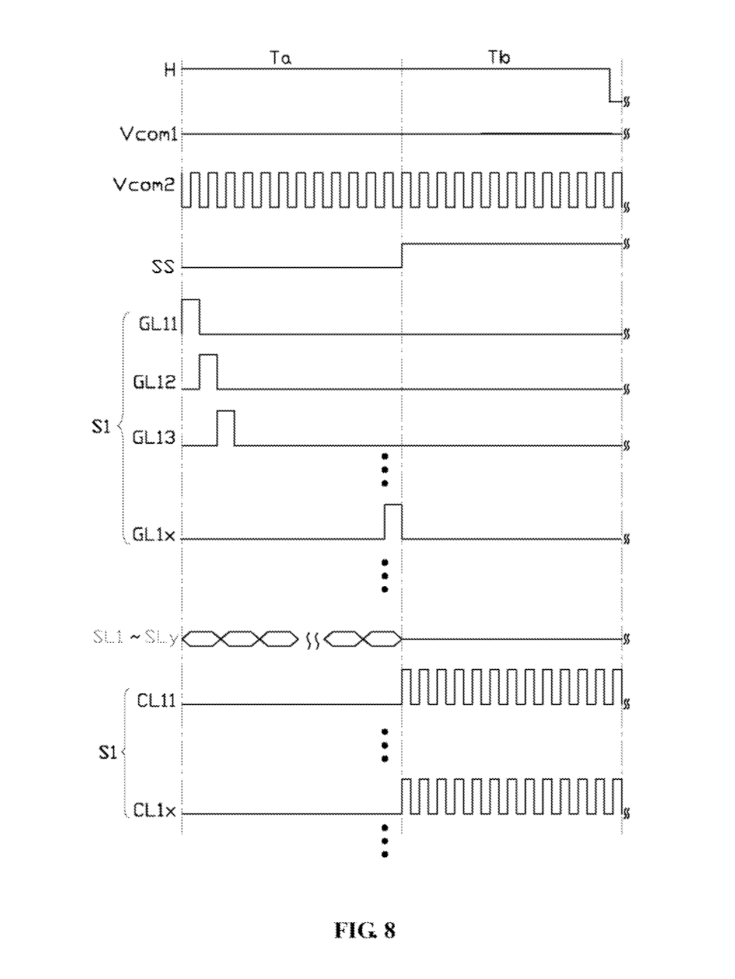

FIG. 8 illustrates a diagrammatic view of an exemplary embodiment of sequential waveforms of an in-cell touch display device. H represents a horizontal synchronizing signal received at the sequence controller 21. The horizontal synchronizing signal can include one or more driving circles T. The sequential waveform illustrated in FIG. 8 is only an exemplary of one of driving circles T1. Each driving circle can include a display scanning period Ta and a touch scanning period Tb. In the exemplary embodiment, duration of Ta is equal to duration of Tb.

SS represents a waveform of the selection signal SS. In the exemplary embodiment, the selection signal SS is a square waveform having a duty cycle of 0.5. In at least one embodiment, the selection signal SS can have other suitable duty cycle as required, for example, 0.8. Vcom1 represents a waveform of the first common voltage. Vcom2 represents a waveform of the second common voltage. GL11, GL12, . . . GL1x represents waveforms of the gate signals

GS received by the gate lines GL11, GL12, . . . GL1x of the first touch sensing area S1. SL1, SL2, . . . Sly represent waveforms of the image data DATA received at the source lines SL1, SL2, . . . Sly of the first touch sensing area S1, CS11, CS12, . . . CS1x represents waveforms of common voltage applied on the common electrode lines CL11, CL12, . . . CL1x of the first touch sensing area S1.

During the display scanning period Ta, the gate lines GL11, GL12, . . . GL1x of the first touch sensing area S1 apply gate signals GS11, GS12, . . . GS1x on corresponding TFT 15 respectively. The TFT 15 is enabled, and the image data DATA is applied on corresponding pixel electrode 1120 through the source lines SL1, SL2, . . . SLy and the TFT 15. At the same time, the selection signal SS is in a low potential, and the selection circuit 26 applies the first common voltage Vcom1 to corresponding common electrodes 114a through the common electrode lines CL11, CL12, . . . CL1x. Therefore, an electric field is generated between two opposite sides of the liquid crystal capacitor LC to drive liquid crystal molecules of the liquid crystal layer 12 to deflect to cause the touch display panel 10 to display images.

During the touch scanning period Tb, the gate lines GL11, GL12, . . . GL1x of the first touch sensing area S1 stop applying gate signals GS11, GS12, . . . GS1x on corresponding TFT 15 respectively. The TFT 15 is disabled, and there is no image data DATA applied on corresponding pixel electrode 1120. At the same time, the selection signal SS is in a high potential, and the selection circuit 26 applies the second common voltage Vcom2 to corresponding common electrodes 114a through the common electrode lines CL11, CL12, . . . CL1x. Therefore, an electric field is generated between two opposite sides of the sensing capacitor Ct. When a touch operation is applied on the touch display panel 10, the electric field in the sensing capacitor Ct is changed, so that a touch signal TS is generated based on the change of the electric field in the sensing capacitor Ct. The touch sensitive circuit 25 can determine a position where the touch operation is applied based on the touch signal TS.

In the same way, during the second driving circle T2, the second touch sensing area S2 displays images during the display scanning period Ta and detects touch operations during the touch scanning period Tb. During the third driving circle T3, the second touch sensing area S3 displays images during the display scanning period Ta and detects touch operations during the touch scanning period Tb. During the n^{th} driving circle Tn, the second touch sensing area Sn displays images during the display scanning period Ta and detects touch operations during the touch scanning period Tb.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A touch display device comprising:
a plurality of pixel electrodes configured to receive image data to be displayed;
a plurality of common electrodes;
a plurality of touch sensitive electrodes;
common voltage generator configured to generate a first common voltage and a second common voltage, wherein the first common voltage is a first direct voltage, and the second common voltage is an alternating voltage switched between a second direct voltage and a third direct voltage; and
a selection circuit coupled between the common voltage generator and the plurality of common electrodes and configured to selectively output the first common voltage to the common electrodes during a first time period and selectively output the second common voltage to the common electrodes during a second time period;
wherein during the first time period, the common electrodes cooperate with the pixel electrodes to display the image data on the touch display device, and during the second time period, the common electrodes cooperate with the touch sensitive electrodes to detect touch operations applied on the touch display device.

2. The touch display device according to claim 1, further comprising a sequence controller configured to receive a horizontal synchronizing signal and to output a selection signal based on the horizontal synchronizing signal to control operation of the selection circuit.

3. The touch display device according to claim 2, wherein the selection signal is a square wave.

4. The touch display device according to claim 3, wherein the square wave has a duty circle of 0.5.

5. The touch display device according to claim 3, wherein the square wave has a duty circle of 0.8.

6. The touch display device according to claim 1, wherein the first time period does not overlap the second time period.

7. The touch display device according to claim 1, wherein the horizontal synchronizing signal comprises a plurality of driving circles, each driving circle including the first time period and the second time period.

8. The touch display device according to claim 7, further comprising a plurality of touch sensitive area, wherein each touch sensitive area is corresponding to one of the plurality of driving circles.

9. A drive method comprising:
receiving, at a touch display device, a horizontal synchronizing signal;
generating, at the touch display device, a selection signal;
applying, at the touch display device, a first common voltage to common electrodes during a first time period, wherein the first common voltage is a first direct voltage based on the selection signal;
applying, at the touch display device, image data to pixel electrodes during the first time period;
displaying, at the touch display device, the image data under cooperation of the common electrodes and the pixel electrodes during the first time period;
applying, at the touch display device, a second common voltage to common electrodes during a second time period based on the selection signal, wherein the second common voltage is an alternating voltage switched between a second direct voltage and a third direct voltage; and
detecting, at the touch display device, a touch operation under cooperation of the common electrodes and touch sensitive electrodes during the second time period.

10. The method according to claim 9, wherein the second time period does not overlap the first time period.

11. The method according to claim 9, wherein the second direct voltage equals to the first direct voltage.

12. The method according to claim 9, wherein the second direct voltage equals to the first direct voltage.

13. The method according to claim 9, wherein the selection signal is a square wave.

14. The method according to claim 13, wherein the square wave has a duty circle of 0.5.

15. The method according to claim 13, wherein the square wave has a duty circle of 0.8.
